(19) United States
(12) Patent Application Publication
(10) Pub. No.: US 2017/0052096 A1
(43) Pub. Date: Feb. 23, 2017

(54) BIOLOGICAL SPECIMEN HANDLING APPARATUS

(71) Applicant: James B. McCormick, Lincolnwood, IL (US)

(72) Inventor: James B. McCormick, Lincolnwood, IL (US)

(21) Appl. No.: 15/236,012

(22) Filed: Aug. 12, 2016

Related U.S. Application Data
(60) Provisional application No. 62/208,550, filed on Aug. 21, 2015.

(51) Int. Cl. G01N 1/36; B01L 3/00

(52) U.S. Cl. CPC G01N 1/36; B01L 3/5055; G01N 2001/366; G01N 2001/364; B01L 2300/0809; B01L 2400/084; B01L 2300/043

(57) ABSTRACT

In one aspect, a cassette for handling a biological specimen is provided including a compartment having a bottom wall, a front wall, a rear wall, and a pair of side walls. The compartment includes at least one curved juncture connecting the bottom wall and one of the front, rear, and side walls. The at least one curved juncture curves upwardly away from the bottom wall with a curvature that matches a portion of an Archimedean spiral. In another aspect, an apparatus is provided that includes a cassette and a metallic base mold including an upper cavity for receiving the cassette. The metallic base mold includes a cam member configured to direct the cassette downward into the upper cavity as user urges the cassette against the cam member.

### CROSS-REFERENCE TO RELATED APPLICATION

This application claims the benefit of U.S. Provisional Patent Application No. 62/208,550, entitled “Biological Specimen Handling Apparatus” and filed Aug. 21, 2015, which is hereby incorporated by reference in its entirety.

### FIELD OF THE INVENTION

The invention relates to embedding biological specimens for histological examination and, more particularly, relates to improved apparatus and methods for embedding tissue specimens in wax or the like in preparation for microtome sectioning and microscopic examination.

### BACKGROUND

Standard procedures for preparing tissue specimens for microscopic examination involve multiple processes that end with infiltrating the tissue specimen with paraffin, embedding the tissue specimen in paraffin wax, and sectioning the paraffin-embedded tissue specimen very thinly with a microtome.

Typically, prior to embedding, the tissue specimen is positioned within a cassette and treated by fixing, washing, dehydrating, clearing, and saturating the tissue specimen with various pre-embedding treatment fluids, including formaldehyde and water, ethanol, xylene while the tissue specimen is within the cassette. One or more of the fluids may circulate within the cassette while contacting the tissue specimen. After treatment by the various pre-embedding treatment fluids, the tissue specimen is infiltrated with paraffin wax and is subsequently embedded in paraffin wax.

To embed the tissue specimen in paraffin wax, a molten embedding material such as a paraffin wax compound is poured into a cavity of a mold to partially fill the mold cavity. The mold is moved to a cooling station where a bottom wall of the mold cavity is placed on a cooling rail to solidify or gel the paraffin in the mold cavity. Next, the prepared tissue specimen is placed onto the gelled paraffin in the cavity of the mold. Positioning the tissue specimen onto the gelled paraffin involves orienting the tissue specimen to best present the specimen to the cutting blade of a microtome. The tissue specimen is oriented such that consecutive cross sections produced from the tissue specimen show features of the tissue specimen throughout the tissue specimen. For example, a relatively long and thin tissue specimen may be oriented to extend substantially normal to a bottom wall of the mold cavity so that a healthcare provider can view the sequential longitudinal cross sections and understand the features of the tissue specimen along its length.

Molten paraffin is then poured over the tissue specimen. A cassette is placed over the cavity in the mold and additional molten paraffin is poured over the cassette. After the paraffin solidifies, a cast block is formed that includes a base portion of the cassette and a paraffin block portion having the tissue specimen disposed within the block portion. The cassette operates as a specimen carrier that is placed within a chuck of the microtome. While the cassette is held in the chuck of the microtome, the cutting blade of the microtome slices the block portion with the tissue specimen embedded therein.

For some prior tissue embedding systems, a user applies downward force with her finger(s) against the cassette to seat the cassette within the mold before pouring the paraffin over the cassette and tissue specimen in the mold. Molten paraffin at 56-58° C. has a reduced viscosity and will creep in a manner similar to hot oil between mated surfaces of the cassette and mold. If the cassette is not fully seated within the mold, molten paraffin may creep into gaps between the mold and the cassette. The paraffin in these gaps hardens and may form a flash on the cassette. After the cassette and embedded tissue specimen have been removed from the mold, the paraffin flash may interfere with positioning of the cassette in the chuck of the microtome and may negatively affect the accuracy of the slicing operation. The force the user applies against the cassette to seat the cassette within the mold may vary as the paraffin hardens. Further, the force applied to seat cassettes within the mold may vary from tissue specimen to tissue specimen, as well as from user to user. Thus, it is difficult to limit paraffin flash created by these prior tissue embedding systems. Further, the paraffin flash may have to be manually trimmed from the cassette in order to properly position the cassette in the chuck of the microtome. This manual removal of the paraffin flash delays processing of the tissue specimen.

One prior apparatus for embedding tissue specimens is disclosed in U.S. Pat. No. 5,269,671. The '671 Patent discloses a system having a cassette and an embedding mold with a well for reception of a specimen. The mold has a back wall with a series of retaining flanges that extend over and retain a back wall of the cassette when the cassette is positioned in the embedding mold. The front wall of the mold has a resilient restraining strip for engagement with a front wall of the cassette. To position the cassette in the mold, the cassette is slid into the mold at an angle so that the back wall of the cassette slides underneath the retaining flanges of the back wall of the embedding mold. A user then presses downward on the cassette to pivot the cassette downward, which moves the restraining strip on the front wall of the mold out of the way of the forward tip of the cassette as the cassette pivots downward. The resilient restraining strip snaps back into place above the forward tip of the cassette to lock the cassette within the embedding mold. Although the resilient restraining strip and the retaining flanges of the mold of the '671 patent may securely hold the cassette within the mold, it may be difficult to disengage the restraining strip and retaining flanges of the mold from the cassette and remove the cassette from the mold.

A commercially available mold in accordance with the disclosures of the '671 patent was made of a plastic material that could deflect to permit the forward tip of the cassette to move the restraining strip of the mold out of the way of the forward tip with downward pivoting of the cassette. The plastic material increased the time to cool the paraffin due to the conduction properties of plastic. Further, the paraffin becomes a solid mass when it cools and forms the cast paraffin block. Extraction of the tissue specimen embedded in the cast paraffin block was sometimes difficult because the plastic mold had oleophilic properties that cause difficulty in separation of the mold and the cast paraffin block.

### SUMMARY

In accordance with one aspect of the present invention, a generally rectangular cassette is provided for handling a biological specimen. The cassette includes a biological specimen-receiving compartment including a bottom wall and a front wall, a rear wall, and a pair of side walls that extend obliquely to the bottom wall. The compartment further includes at least one curved juncture connecting the bottom wall and one of the front wall, rear wall, and side walls. The at least one curved juncture curves upward away from the bottom wall with a curvature that matches a portion of an Archimedean spiral. The curvature of the Archimedean spiral provides a gradual transition between the bottom wall and the one of the front, rear, and side wall which extends obliquely to the bottom wall. This, in turn, reduces capillary forces that tend to draw smaller biological specimens, such as less than 0.5 mm across, toward the intersection between the bottom wall and the one wall. Further, the curvature of the Archimedean spiral makes the curved juncture more slippery and reduces the likelihood of the biological specimen becoming caught in the curved juncture.

In one form, the at least one curved juncture includes at least four curved junctures. The curved junctures connect the bottom wall to the front wall, the rear wall, and the side walls. Because all of the front wall, rear wall, and side walls have curved junctures with the bottom wall, smaller biological specimens can slide down the curved juncture and onto the bottom wall after treatment with pre-embedding treatment fluid rather than being stuck on the front, rear, and side walls.

In accordance with another aspect, a generally rectangular cassette for handling a biological specimen is provided. The cassette includes a biological specimen-receiving compartment having a bottom wall and a front wall, a rear wall, and a pair of side walls that extend obliquely to the bottom wall. The cassette further includes at least one curved corner connecting one of the side walls to one of the front wall and the rear wall. The at least one curved corner widens as the curved corner extends away from the bottom wall. The curved corner improves circulation of pre-embedding treatment fluids within the compartment by reducing turbulence caused by the transition between the one side wall and the one front and rear wall.

In accordance with another aspect of the present invention, a biological specimen handling apparatus is provided having a generally rectangular cassette for supporting a tissue specimen and a base mold of metallic material having a body including a lower cavity for receiving the tissue specimen and a generally rectangular upper cavity sized to receive the cassette. The metallic base mold has a cam member configured to direct the cassette downward into the upper cavity as a user urges the cassette against the cam member without causing deflection of the cam member relative to the base mold body. The cam member permits the user to urge the cassette against the cam member which tightly seats the cassette in the upper cavity of the base mold and reduces migration of molten paraffin that could form a flash between the cassette and the mold. By reducing the paraffin flash formed between the cassette and base mold, the cassette with embedded tissue specimen may be placed in a microtome without the difficulty and delay involved in trimming flash from the cassette.

In one form, the upper cavity of the rigid base mold includes a generally horizontally extending shelf surface for supporting a lower surface of the cassette. The cam member extends at an acute angle relative to the horizontal extending shelf surface of the base mold. The cassette has an inclined front wall that extends at an acute angle relative to a lower surface of the cassette. The inclined front wall of the cassette engages the cam member and is urged downward toward the shelf surface as the user urges the cassette against the cam member. This tightly seats the lower surface of the cassette against the shelf surface and inhibits hot wax migration with flash formation at the junction of the cassette lower surface and the base mold shelf surface. The acute angles of the cam member of the base mold and the inclined front wall of the cassette may be substantially equal, and both angles may be approximately forty-five degrees.

In accordance with another aspect, a biological specimen handling apparatus is provided including a cassette having upper and lower surfaces and height therebetween and a base mold having an upper cavity for receiving the cassette. The upper cavity has a support surface for supporting the lower surface of the cassette and a rear wall sized to extend upwardly along a rear wall of the cassette once the cassette has been received in the upper cavity. The base mold also includes a front cam member disposed across the upper cavity from the rear wall and being configured to direct the cassette downward into the upper cavity as the user urges the cassette along the support surface and against the cam member. Thus, the shorter rear wall of the upper cavity increases the ease with which the user can position the cassette in the upper cavity and the front cam member assists in securely seating the cassette in the upper cavity and limiting the formation of paraffin flash.

In one form, the base mold is metallic and the front cam member and the rear wall are configured to permit the cassette to be seated in the upper cavity without deformation of the front cam member and the rear wall. This makes the apparatus easier to use because the user does not need to deform the base mold in order to position the cassette therein.

### BRIEF DESCRIPTION OF THE DRAWINGS

FIG. 1 is an exploded view of a cassette and a base mold for use in treating a tissue specimen with various solutions and embedding the tissue specimen in a block of paraffin wax;

FIG. 2 is a top plan view of the base mold of FIG. 1 showing a generally rectangular upper cavity of the base mold and a cam member at one end of upper cavity;

FIG. 3 is a cross-sectional view taken across line 3-3 in FIG. 2 showing the cam member extending at an acute angle relative to a shelf surface of the upper cavity that supports the cassette;

FIG. 4 is a cross-sectional view taken across line 4-4 in FIG. 2 showing the cam member extending upwardly from a front wall of the base mold;

FIG. 5 is a cross-sectional view similar to FIG. 3 showing the cassette being advanced into the upper cavity of the base mold;

FIG. 6 is a cross-sectional view similar to FIG. 5 showing the cassette received in the upper cavity of the base mold;

FIG. 7 is a cross-sectional view similar to FIG. 5 showing molten paraffin having been poured over the cassette after the cassette was securely seated in the upper cavity using the cam member;

FIG. 8 is a cross-sectional view similar to FIG. 5 showing the rear end of the cassette being pivoted upwardly to withdraw the hardened block of paraffin and tissue specimen therein from the mold;

FIG. 9 is an enlarged cross-sectional view of the area shown in the dashed circle of FIG. 4 showing the cassette seated by a side wall of the upper cavity of the mold;

FIG. 10 is a perspective view of another base mold showing a generally rectangular upper cavity of the base mold and a cam member at one end of upper cavity;

FIG. 11 is a cross-sectional view taken across line 11-11 in FIG. 10 showing the cam member extending at an acute angle relative to a shelf surface of the upper cavity that supports the cassette;

FIG. 12 is a cross-sectional view taken across line 12-12 in FIG. 10 showing the cam member extending upwardly from a front wall of the base mold;

FIG. 13 is a exploded view of another cassette and base mold showing a lid of the cassette pivotally attached to a body of the cassette;

FIG. 14 is a cross-sectional view taken across line 14-14 in FIG. 13 showing a cam member of the base mold extending at an acute angle relative to a shelf surface of an upper cavity of the base mold;

FIG. 15 is a cross-sectional view taken across line 15-15 in FIG. 13 showing the cam member extending upwardly from a front wall of the base mold;

FIG. 16 is a plan view of the cassette of FIG. 13 showing a bottom wall, a front wall, a rear wall, and side walls of a compartment of the cassette;

FIG. 17 is a cross-sectional view taken across line 17-17 in FIG. 16 showing curved junctures between the front and rear walls and the bottom wall;

FIG. 18 is a schematic view of a portion of FIG. 17 showing the curved juncture connecting the bottom wall to the rear wall having a curvature that matches a portion of an Archimedean spiral;

FIG. 19 is a cross-sectional view taken across line 19-19 in FIG. 16 showing a curved juncture between a corner wall of a curved corner of the compartment and the bottom wall;

FIG. 20 is a cross-sectional view taken across line 20-20 in FIG. 19 showing the corner wall having a first radius near the bottom wall;

FIG. 21 is a cross-sectional view taken across line 21-21 in FIG. 19 showing the corner wall having a second radius higher on the corner wall that is larger than the first radius; and

FIG. 22 is a cross-sectional view taken across line 22-22 in FIG. 19 showing the corner wall having a third radius higher on the corner wall that is larger than the second radius.

### DETAILED DESCRIPTION

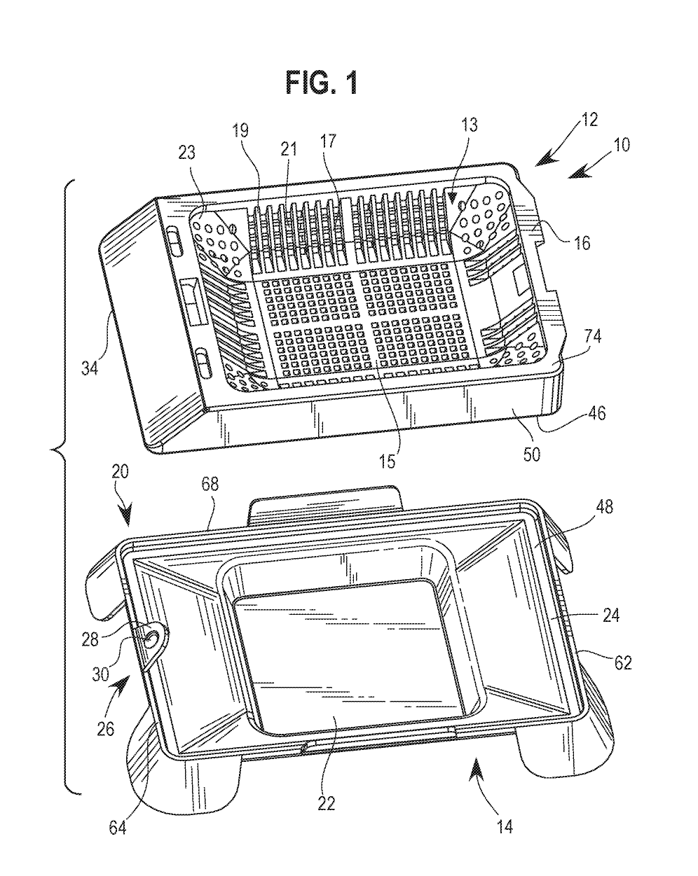

With reference to FIG. 1, an apparatus 10 for handling biological specimens is provided including a cassette 12 and an embedding mold 14. The cassette 12 has a compartment 13 for receiving a biological specimen, such as a tissue specimen. The compartment 13 includes a bottom wall 15 and a plurality of walls 17 oriented to extend obliquely to the bottom wall 15. The bottom wall 15 and the walls 17 include apertures 21 that permit various pre-embedding fluids to enter and exit the compartment 13 and contact the tissue specimen received therein during pre-embedding processing procedures. The compartment 13 further includes one or more curved junctures 19 connecting the walls 17 to the bottom wall 15. The curved junctures 19 have a curvature that matches a portion of an Archimedean spiral. The curvature of the curved junctures 19 reduces the capillary action created by the obliquely-extending walls 17 and encourages smaller tissue specimens, such as less than 0.5 mm across, to settle toward the center of the compartment 13. Additionally, the compartment 13 includes curved corners 23 that improve circulation of pre-embedding treatment fluids within the compartment 13 by reducing turbulence caused by the transition between the walls 17.

With respect to FIG. 1, the cassette 12 may have a body 16 and a cover releasably connected to the body 16 for retaining a tissue specimen within the cassette 12 during pre-embedding processing procedures. The base mold 14 has a body 20 with a lower cavity 22 that receives a tissue specimen after processing and an upper cavity 24 sized and shaped to receive the cassette 12 therein. The base mold 14 has a cam member 26 that may include a tab 28 and an arcuate projection, such as a dimple 30. The dimple 30 operates as a force director point that creates a downwardly-directed force vector on the cassette 12 that reduces paraffin flash between the cassette 12 and base mold 14 as discussed in greater detail below.

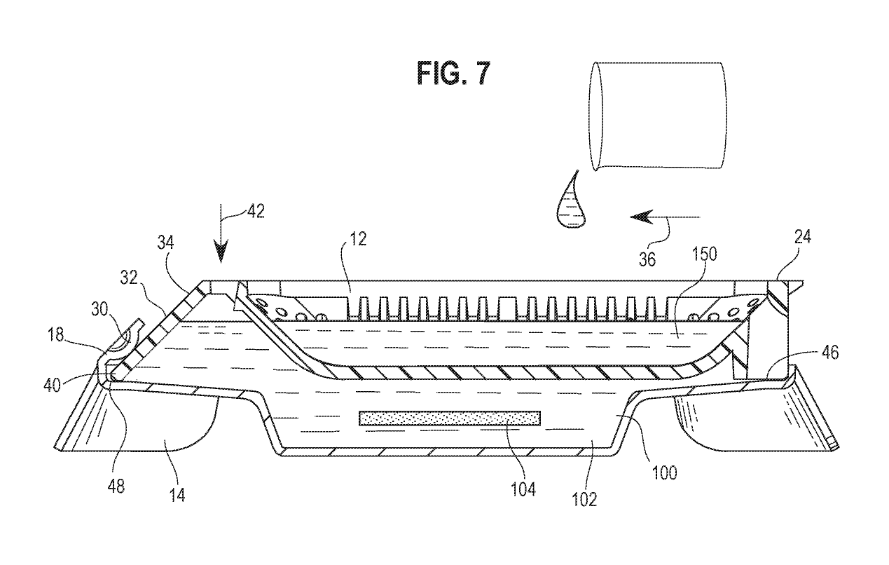

With reference to FIG. 7, the dimple 30 engages an inclined surface 32 of a front wall 34 of the cassette 12 and produces a camming action on the cassette 12 as a user urges the cassette 12 in direction 36 toward the tab 28. The inclined surface 32 may be written on or printed on by a user to identify the tissue specimen. The camming action converts input force against the cassette 12 in one direction 36 into shifting of the cassette 12 in another, transverse direction 42. Further, the camming action between the dimple 30 and the inclined surface 32 of the front wall 34 directs a front end 40 of the cassette 12 downward in direction 42 to tightly engage a lower surface 46 of the cassette 12 against a shelf surface 48 of the base mold 14. This tight engagement reduces the formation of flash along the lower surface 46 and side walls 50 of the cassette 12. By reducing the formation of paraffin flash, the cassette 12 and embedded tissue specimen may be readily positioned in a chuck of a microtome without having to trim paraffin flash from the cassette 12. This improves the accuracy of the microtome slicing operation and permits more efficient processing of the tissue specimen.

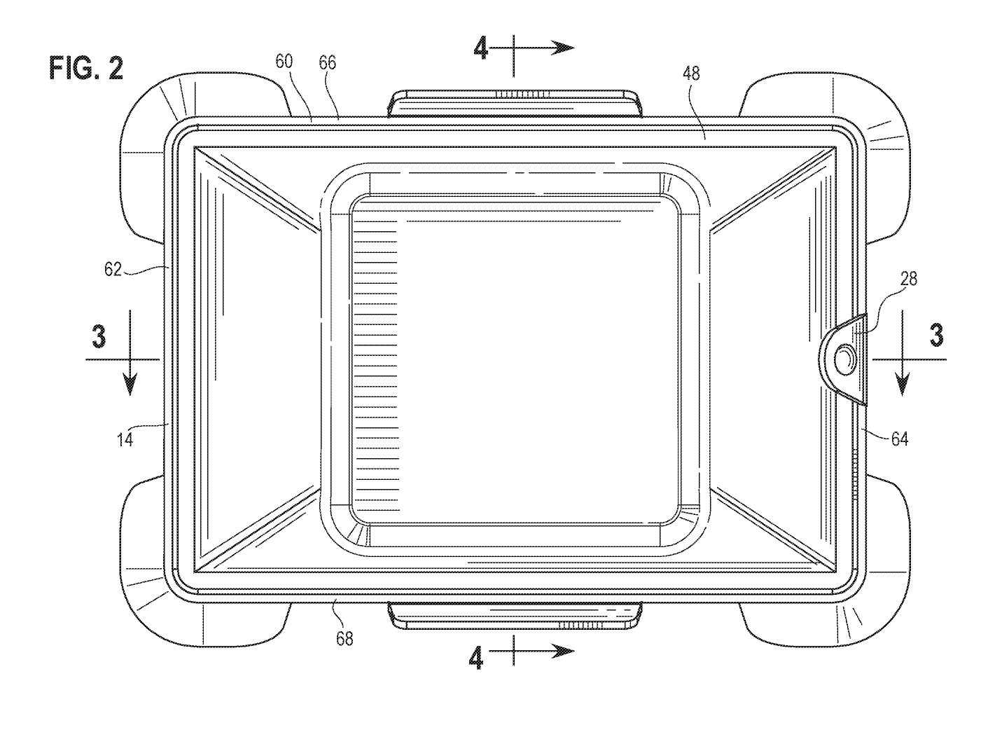

With reference to FIGS. 1 and 2, the base mold 14 has a generally rectangular shape and is made of a rigid material. As used herein, the term rigid material is intended to encompass materials that retain their shape without deflection or deformation during normal use of the base mold 14 for embedding tissue specimens. The base mold 14 may be made of a metallic material, such as stainless steel. The base mold 14 may be made of other metallic materials such as copper, brass, nickel, and heat conductive alloys. The metallic material permits the base mold 14 to be cleaned with solvents and detergents or autoclave and then reused, which provides cost savings. The metallic material may also provide better heat transfer from a cooling rail to the paraffin within the base mold 14 when compared to plastic molds. This improves efficiency by decreasing the duration of the embedding process whether the embedding process is performed manually or by automated approaches. As yet another example, the base mold 14 may be made of glass or a ceramic material. The properties of the glass or ceramic material are selected to provide the desired heat transfer and ease of cleaning properties desired for a particular application.

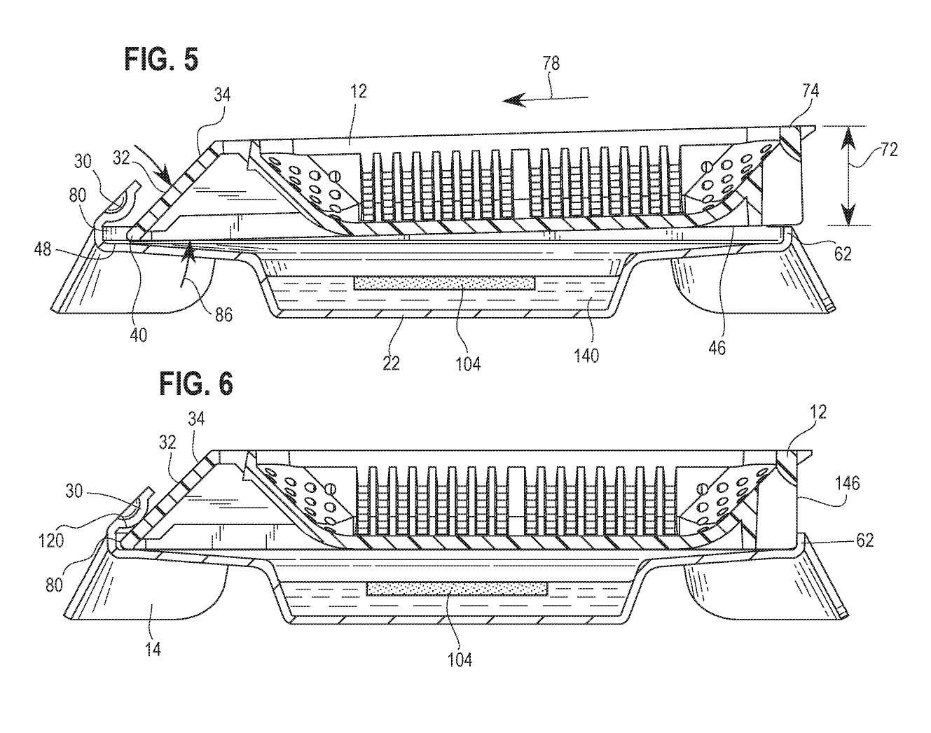

With reference to FIGS. 1 and 2, the body 20 includes one or more walls 60 upstanding from the shelf surface 48. The walls 60 may include a rear wall 62, a front wall 64, and a pair of side walls 66, 68 connecting the rear wall 62 and the front wall 64. The walls 62, 64, 66, 68 may all be shorter than a height 72 (see FIG. 5) of the cassette 12 to limit interference from the walls 62, 64, 66, 68 as the cassette 12 is inserted into and removed from the upper cavity 24. In this manner, the user does not need to deform the base mold 14 to insert and remove the cassette 12 from the upper cavity 24, unlike the embedding mold disclosed in U.S. Pat. No. 5,269,671 and discussed above.

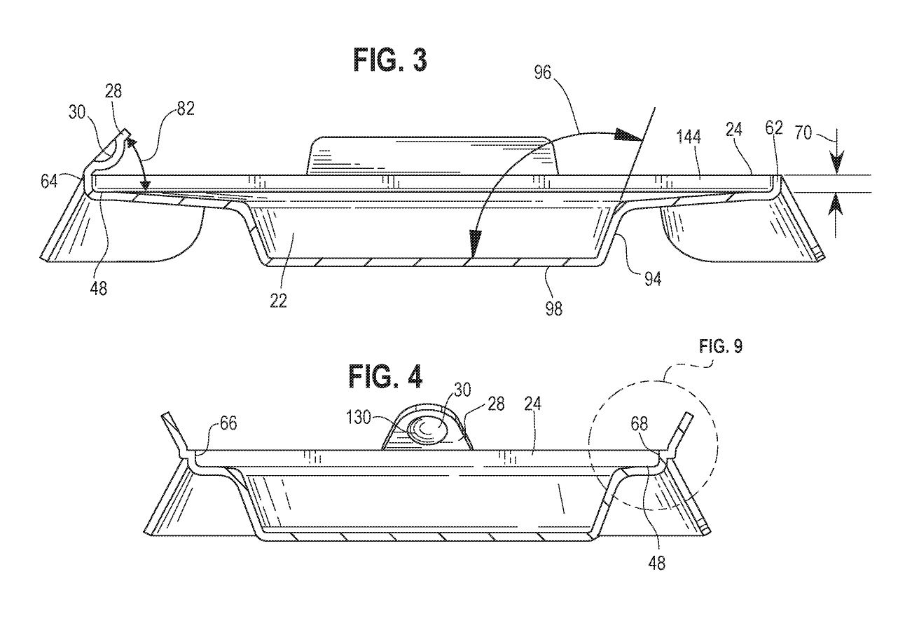

With reference to FIGS. 3 and 5, the height 72 of the cassette 12 may be measured between an upper surface 74 and the lower surface 46 of the cassette 12. The walls 62, 64, 66, 68 may have a common height 70 that is shorter than the height 72 of the cassette 12. The height 70 may be less than three-quarters the height 72, may be less than one-half the height 72, may be less than one-third the height 72, may be less than one-quarter the height 72, and may be less than one-fifth the height 72. For example, the height 72 may be approximately 5 mm and the height 70 may be approximately 1 mm.

With reference to FIG. 5, the low-profile of the rear wall 62 permits the front end 40 of the cassette 12 to be advanced in direction 78 into a gap 80 between the dimple 30 and the shelf surface 48 during positioning of the cassette 12 into the upper cavity 24. With reference to FIG. 3, the tab 28 extends at an acute angle 82 relative to the shelf surface 48, which generally extends horizontally in an annular shape completely around the lower cavity 22. The angle 82 may be in the range of approximately 30 degrees to approximately 60 degrees, such as approximately 45 degrees. The angle 82 corresponds to an angle 86 of the inclined front surface 32 of the cassette 12 as shown in FIG. 5. The angle 86 may be in the range of approximately 30 degrees to approximately 60 degrees, such as approximately 45 degrees. The mating angles 82, 86 position the dimple 30 to cammingly engage the inclined surface 32 of the cassette 12 and direct the cassette 12 downwardly against the shelf surface 48 as the user urges the cassette 12 in direction 36 (see FIG. 7). The angles 82, 86 may differ such as the angle 82 of the tab 28 being 44 degrees and the angle 86 of the front surface 32 being 46 degrees.

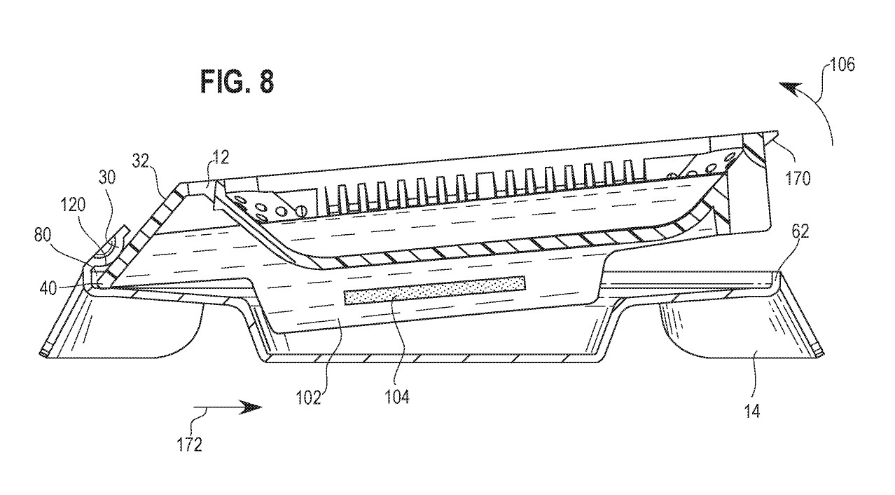

Returning to FIG. 3, the lower cavity 22 includes inclined walls 94 generally extending at angle 96 relative to a bottom wall 98 of the lower cavity 22. The angle 96 may be in the range of approximately 100 degrees to approximately 120 degrees, such as approximately 110 degrees. The angle 96 is selected to permit a mold portion 100 of a paraffin block 102 containing a tissue specimen 104 to be withdrawn from the lower cavity 22 by pivoting the cassette 12 in direction 106 pivoting the cassette 12 about the dimple 30 in direction 106, shown in FIGS. 7 and 8 and discussed in greater detail below.

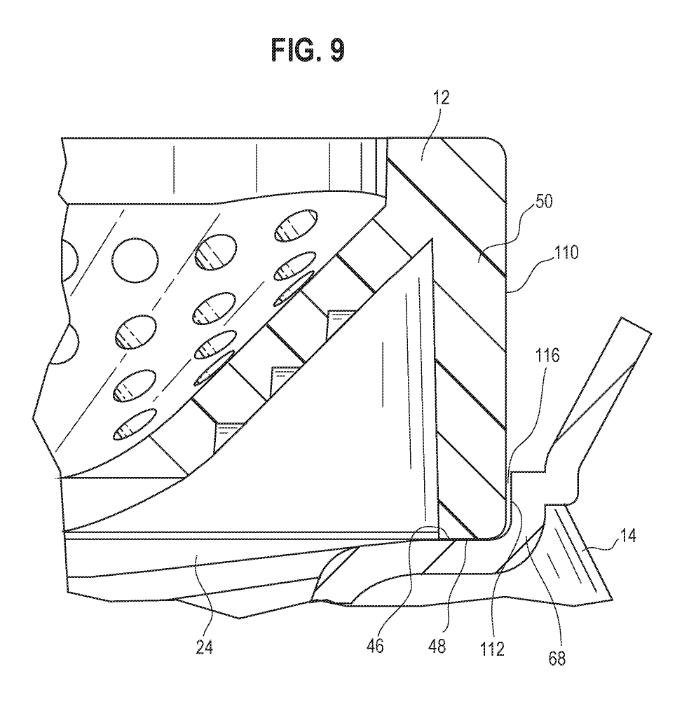

With reference to FIGS. 1 and 9, the cassette has outer side walls 50 with side surfaces 110 that face inner surfaces 112 of the side walls 66, 68. As discussed above, the dimple 30 urges the cassette 12 downwardly against the shelf surface 48 to form a tight engagement therebetween as the user urges the cassette 12 against the dimple 30. This reduces molten paraffin creep into the interface between the cassette lower surface 46 and the base mold shelf surface 48. Further, this reduces the molten paraffin creep into an area 116 between the side surface 110 and the inner surface 112. Thus, the lower surface 46 and the side surface 110 of the cassette may be substantially free of paraffin flash once the paraffin has hardened into the paraffin block 102.

With reference to FIGS. 4 and 6, the dimple 30 has a curved contact cam surface 130 that is convexly curved to face inwardly toward the upper cavity 24. The curved contact surface 130 may form a point contact with the inclined surface 32 of the front wall 34 of the cassette 12. It has been discovered that this point contact is particularly advantageous in some approaches as it reduces the contact area between the tab 28 and the inclined surface 32 of the cassette 12. The reduced contact area provides a smaller space between the tab 28 and the inclined surface 32 that molten paraffin may creep into due to the capillary action. The contacting dimple 30 and the cassette inclined surface 32 thereby reduce the volume of the paraffin that may creep up along the inclined surface 32. This further reduces the paraffin flash formed between the cassette 12 and the base mold 14.

With reference to FIG. 5-8, a method of embedding the tissue specimen 104 in the paraffin block 102 is disclosed. With reference to FIG. 5 the user initially pours a first pour of paraffin 140 into the lower cavity 22 and positions the tissue specimen 104 onto the first pour 140. Another smaller volume of paraffin 140 may be poured over the tissue specimen 140 before the cassette 12 is advanced into the upper cavity 24. Although the following discussion refers to a user performing the steps of the method, it will be appreciated that one or more of the steps may be performed by automated machine(s).

The user then advances the front end 40 of the cassette 12 into an opening 144 (see FIG. 3) of the upper cavity 24 in direction 78. With reference to FIG. 6, the user has fully advanced the cassette 12 in direction 78 until the front end 40 is positioned in the gap 80. Further, a rear wall 146 of the cassette 12 is positioned inward from the rear wall 62 of the base mold 14.

With reference to FIG. 7, the user next pours a second pour 150 of paraffin to fill the cassette 12 and the cavities 22, 24 of the base mold 14. Prior to or generally simultaneously with this second pour 150, the user presses downwardly in direction 42 against the cassette 12 to seat cassette lower surface 46 against the base mold shelf surface 48. Further, the user urges the cassette 12 in direction 36 along the base mold shelf surface 48. It will be appreciated that the distance between the front and rear walls 64, 62 may be sized so that there is only a small or nominal movement of the cassette 16 due to the user urging the cassette 12 in direction 36.

The dimple 30 of the tab 28 cams against the inclined surface 32 of the cassette as the user urges the cassette 12 in direction 36. This camming action urges the inclined wall 34 of the cassette 12 downwardly in direction 42 to clamp the lower surface 46 of the cassette 12 against the shelf surface 48 of the base mold 14. Thus, the camming action in direction 42 provided by the dimple 30 operates in conjunction with the application of force by the user in direction 42 to provide a higher clamping force of the cassette 12 against the base mold 14. The clamping of the cassette 12 against the mold 14 forms a seal between the cassette and mold surfaces 46, 48 that resists ingress of flash-forming molten paraffin between the cassette 12 and the base mold 14.

With reference to FIG. 8, the user may lift upward on a rear lip 170 of the cassette 12 in direction 106 to withdraw the cassette 16 and the embedded tissue specimen 104 after hardening of the paraffin. Because the front end 40 of the cassette 12 is positioned in the gap 80 below the dimple 30, lifting the lip 170 in direction 106 generally causes the cassette 12 to pivot about the dimple 30. The inclined surface 32 of the cassette 12 can slide about the curved contact surface 120 of the dimple 30 to permit the cassette front end 40 to be withdrawn out of the gap 80 generally in direction 172. In this manner, the cassette 16 and hardened block 102 with tissue specimen 104 therein may be easily withdrawn from the base mold 14 with one finger. Further, the cassette 12 may be withdrawn from the base mold 14 without having to deform or deflect the base mold 14 to release the cassette 12 therefrom.

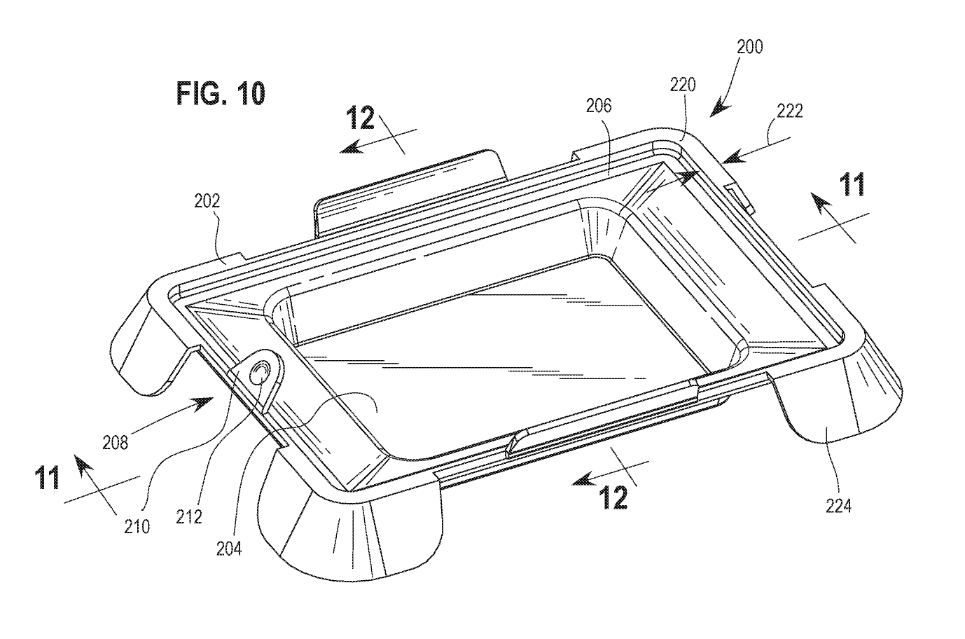

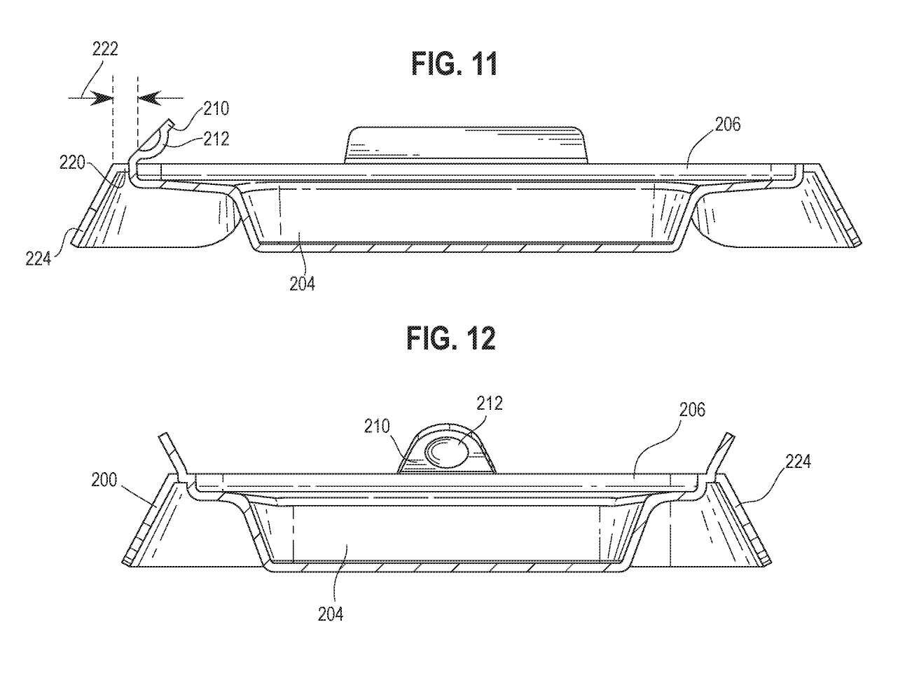

With reference to FIGS. 10-12, another base mold 200 is provided that is similar in many respects to the base mold 14 discussed above. The base mold 200 has a body 202 with a lower cavity 204 that receives a tissue specimen and an upper cavity 206 that receives a cassette similar to the cassette 12 discussed above. The base mold 200 has a cam member 208 that includes a tab 210 and a dimple 212. One difference between the base molds 14, 200 is that the base mold 200 has a peripheral land 220 with a width 222. In one approach, the mold 200 has legs 224 that are bent downwardly during the manufacturing process. The width 222 of the land 220 provides material to permit the downward bending of the legs 224 without affecting the geometry of the cavities 204, 206.

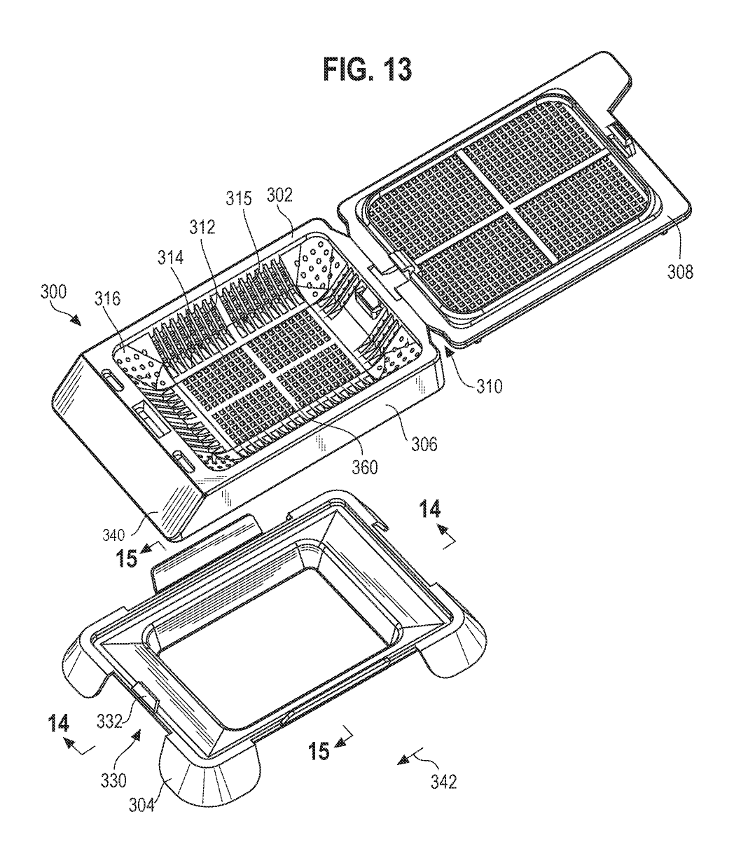

With reference to FIGS. 13-22, another apparatus 300 is provided that is similar in many respects to the apparatus 10 discussed above. The apparatus 300 includes a cassette 302 and a base mold 304. The cassette 302 has a body 306 that is substantially identical to the body 16 of the cassette 12 discussed above. The cassette 302 further includes a cover 308 connected to the body 306 at a hinge 310. Like the cassette 12 discussed above, the cassette 302 has a compartment 312 for receiving a biological specimen, such as the tissue specimen 104. The compartment 312 includes a bottom wall 360, walls 315 extending obliquely to the bottom wall 360, curved junctures 314 connecting the walls 315 to the bottom wall 360, and curved corners 316 interconnecting the walls 315. The curved junctures 314 and the curved corners 316 improve circulation of pre-embedding treatment fluids within the compartment 312 and encourage the tissue specimen to remain near the center of the compartment 312.

For example, U.S. Pat. No. 5,928,934 discloses a cassette having an open container with angled corners between a bottom wall of the open container and front, back, and side walls of the open container. It has been discovered that front, back, and side walls create a capillary action along the wall when the cassette and tissue specimen therein is partially or completely submerged in pre-embedding treatment fluid. This capillary action draws smaller tissue specimens, such as less than 0.5 mm across, to migrate up along the angled corners and walls of the open container of the '934 patent. These smaller tissue specimens may become caught in the angled corner between the bottom wall and the front, back, and side walls which complicates visually locating the tissue specimen and removing the tissue specimen using forceps. The cassette of the '934 patent also has angled corners connecting the front, rear, and side walls. It has been discovered that these angled corners of the cassette of the '934 patent create turbulence in pre-embedding treatment fluids when the fluids are circulated within the compartment.

In comparison to the cassette of the '934 patent, the curved junctures 314 reduce the capillary action that tends to draw smaller tissue specimens toward the walls 315. The curved junctures 314 reduce the capillary action by gradually transitioning between the surfaces of the bottom wall 360 and the walls 315. Due to the more gradual transition, the intermolecular forces between the fluids and the material of the cassette 302 are dispelled. Because there is reduced capillary action in the pre-embedding treatment fluid at the curved junctures 314, the reduced capillary action is less able draw smaller tissue specimens toward the walls 315 and corners 316. In this manner, the smaller tissue specimens are subject to reduced forces drawing the smaller tissue specimens toward the curved junctures 314 and tend to remain more centered in the compartment 312.

As another comparison to the cassette of the '934 patent, the curved corners 316 improve the circulation of pre-embedding treatment fluids within the compartment 312. More specifically, the angled corners connecting the front, rear, and side walls of the cassette of the '934 patent form a right angle in a cross-section taken parallel to the bottom floor of the cassette of the '934 patent. When pre-embedding treatment fluids are circulated within the open compartment of the '934 patent along the front, rear, and side walls thereof, the angled corners create turbulence and disrupt circulation of the pre-embedding treatment fluids. This disruption may reduce interaction of the pre-embedding treatment fluids with the tissue specimen. In contrast, the curved corners 316 of the cassette 302 provide a smooth transition between the walls 315. Further, the curved corners 316 widen as they extend away from the bottom wall 360 which provides smooth transitions between the walls 315 even as the walls 315 extend away from the bottom wall 360 and become farther and farther apart from each other.

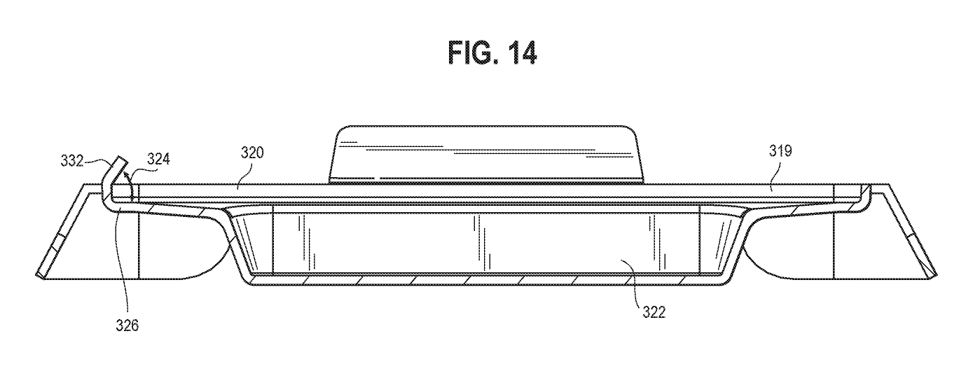

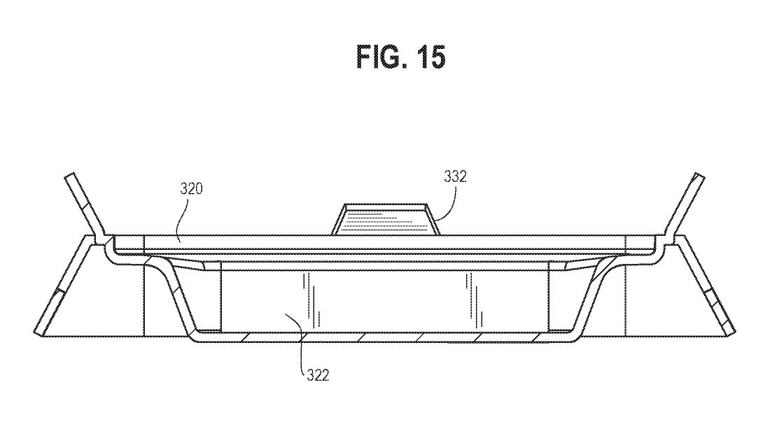

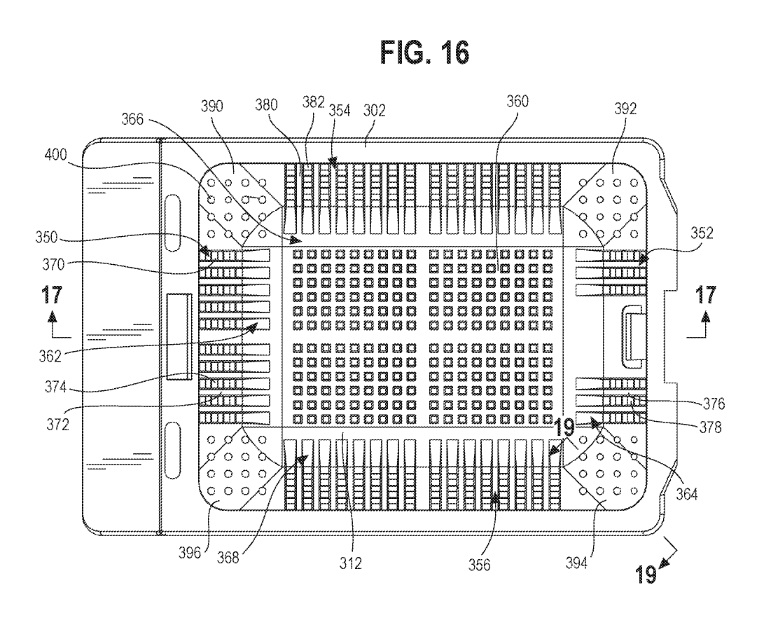

With reference to FIGS. 14 and 15, the base mold 304 includes a body 319 with an upper cavity 320 and a lower cavity 322. The upper cavity 320 receives the cassette 302 and the lower cavity 322 receives a tissue specimen after the tissue specimen has been treated with the pre-embedding treatment fluids (see above discussion of FIGS. 5-8). The body 319 further includes a cam member 330, such as a tab 332 that extends at an acute angle 324 relative to a seating surface 326 of the upper cavity 320. The tab 322 engages a front surface 340 of the cassette 302 when the cassette 302 is advanced in direction 342 (see FIG. 13) into the upper cavity 320 and cams the cassette 302 against the seating surface 326, in a manner similar to the tab 28 discussed above.

With reference to FIG. 16, the walls 315 of the cassette compartment 312 includes a front wall 350, a rear wall 352, and side walls 354, 356. The curved junctures 314 include junctures 362, 364, 366, and 368 connecting the bottom wall 360 to the front wall 350, rear wall 352, and side walls 354, 356. In one form, all of the bottom wall 360, the front wall 350, the rear wall 352, and the side walls 354, 356 have apertures 370 therein to permit treatment fluid to easily enter and exit the compartment 312 during tissue specimen processing.

In one form, the front wall 350 includes wall members 372 separated by apertures 374. Likewise, the rear wall 352 includes wall members 376 separated by apertures 378. Further, the side walls 354, 356 include wall members 380 separated by apertures 382.

With continued reference to FIG. 16, the curved corners 316 include corners 390, 392, 394, 396 interconnecting the front wall 350, rear wall 352, and side walls 354, 356. As discussed below, each of the corners 390, 392, 394, 396 has a concave shape and widens as the corners 390, 392, 394, 396 extend upward away from the bottom wall 360. Additionally, the corners 390, 392, 394, 396 have apertures 400 formed therein to permit the ingress and egress of treatment fluid in the areas of the compartment 312 near the corners 390, 392, 394, 396.

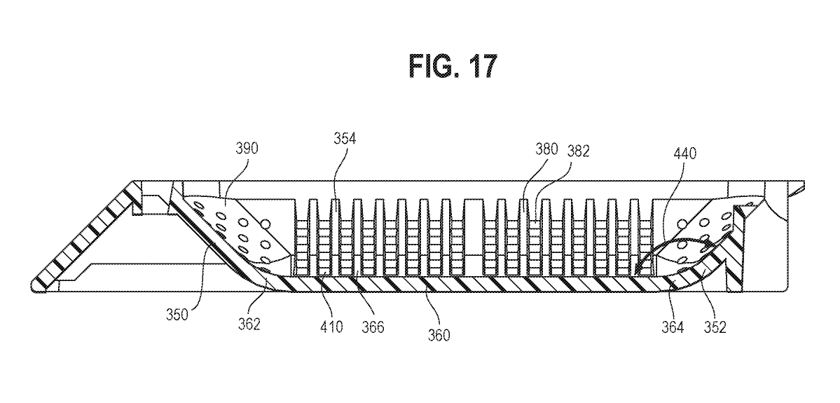

Turning to FIG. 17, the juncture 366 connects the side wall 354 to the bottom wall 360. The juncture 366 may include apertures therein, such as portions 410 of the apertures 382 extending between the wall members 380. The apertures 382 and portions 410 thereof permit pre-embedding treatment fluid to travel horizontally (out of the page in FIG. 17) into the compartment 312 and contact the tissue specimen therein. In another form, the apertures of the junctures 362, 364, 366, and 368 may be separate from the apertures of the front wall 350, rear wall 352, and side walls 354, 356.

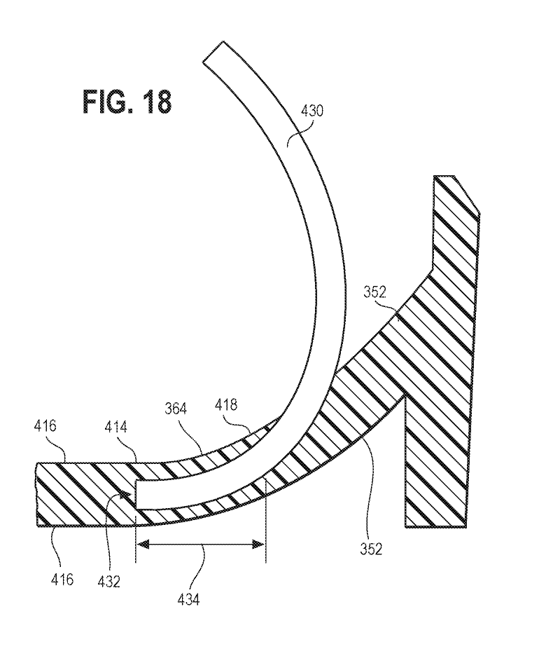

With reference to FIG. 18, the curvature of the juncture 364 will be discussed in greater detail. However, the following discussion applies equally to the junctures 366, 362, and 368 of the cassette 302 as well as the junctures 19 of the cassette 12 discussed above. The compartment 312 has a transition 414 between the generally planar bottom wall 360 and the upwardly curving juncture 364. At the transition 414, an upper, flat surface 416 of the bottom wall 360 transitions to an upper, curved surface 418 of the juncture 364.

In FIG. 18, an Archimedean spiral 430 is superimposed on the cross-section of the juncture 364. The Archimedean spiral 430 has a start point or origin 432 that, in one form, is vertically aligned with the transition point 414 and is at the center (measured vertically in FIG. 18) of the bottom wall 360. The juncture 364 curves upward away from the bottom wall 360 along a portion 434 of the Archimedean spiral 430. In one form, the juncture 364 curves along the portion 434 because the juncture 364 has a midline, i.e., a line extending through the juncture 364 along points at the center of the material as measured vertically in FIG. 18, extending away from the origin 432 in overlapping or closely overlapping relation to the Archimedean spiral 430 which also extends away from the origin 432.

The Archimedean spiral 430, and the portion 434 of the juncture 364, curves upwardly away from the bottom wall 360 with a curvature that continuously increases as the Archimedean spiral 430 and the juncture 364 curve away from the origin 432 and the bottom wall 360. The Archimedean spiral 430 is the locus of points corresponding to the locations over time of a point moving away from the origin 432 with a constant speed along a line which rotates with constant angular velocity. Equivalently, in polar coordinates R and θ, the Archimedean spiral is described using the following equation:

R=a+b×θ

Wherein the a and b values are real numbers. The parameter a turns the Archimedean spiral 430 while the b value controls the distance between turnings of the spiral.

With reference to FIG. 18, the Archimedean spiral 430 spirals upward, away from the origin 432 with a progressively larger and larger curvature. The Archimedean spiral 430 is truncated in FIG. 18 but would continue to spiral progressively outward from the origin 432 with a fixed distance between turnings of the spiral. One of the properties of the Archimedean spiral 430 is that any ray from the origin 432 intersects successive turnings of the Archimedean spiral 430 at points with a constant distance therebetween. In some forms, the juncture 364 may deviate from the Archimedean spiral equation provided above, such as +/−10 percent of the formula for the Archimedean spiral.

In nature, the Archimedean spiral is expressed in the formation of the smallest shelled sea life as in the family mollusk shells. However small or large, the Archimedean spiral geometry contributes to an optimal fluidic-friendly surface with geometry for the movement of fluid seawater over the inner shell surfaces. In a similar way, the use of the Archimedean spiral for the joining of the walls 315 and the bottom wall 360 of the cassette 302 provides the most favorable geometry for both the movement of processing fluid and the ease of picking up small specimens with tissue forceps in placing and removing specimens for process and retrieval and also for their placement in tissue embedding molds during the process of casting microtomy ready paraffin media blocks as required by microtomy.

Because the juncture 364 matches the curvature of the portion 434 of the Archimedean spiral 430, the juncture 364 reduces the capillary action of the rear wall 352. The reduced capillary action allows smaller tissue specimens to return to the center of the compartment 312 rather than being caught at the juncture 364. Further, the juncture 364 creates a slippery slope that allows a smaller tissue specimen to slide back toward the center of the compartment 312 after treatment of the tissue specimen with pre-embedding treatment fluid within the caste 302.

With reference to FIG. 17, the juncture 364 connects the bottom wall 360 to the rear wall 352. The curved juncture 364 is curved to orient the rear wall 352 to extend at an angle 440 that may be in the range of approximately 130 degrees to approximately 140 degrees, such as approximately 135 degrees. In one form, the front wall 350, rear wall 352, side walls 354, 356 are oriented at a similar angle relative to the bottom wall 360 such as approximately 135 degrees. In another form, one or more of the front wall 350, rear wall 352, and side walls 354, 356 are oriented at a different angle than the remaining walls.

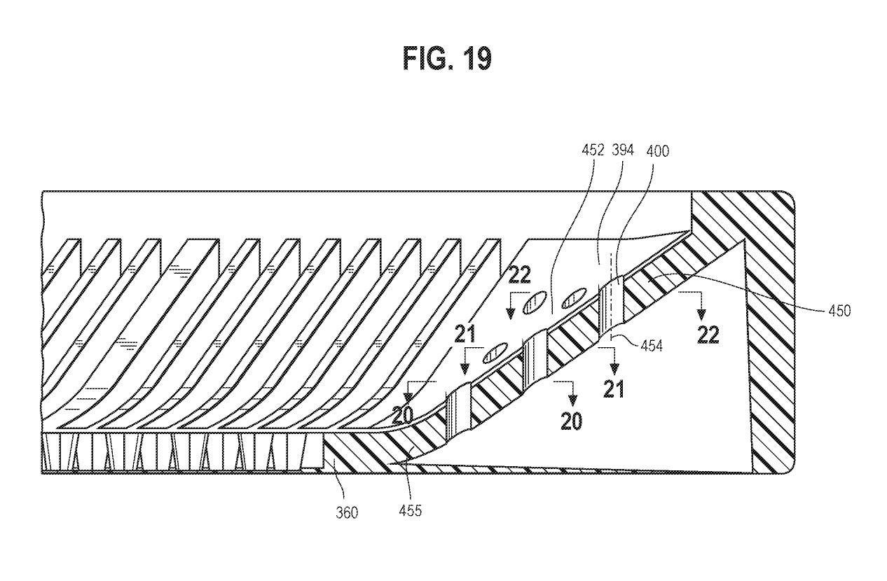

With reference to FIGS. 16 and 19, the corner 394 connecting the rear wall 352 to the side wall 356 will be discussed in greater detail. The following discussion applies to the corners 390, 392, and 396 of the cassette 302 as well as the corners 23 of the cassette 12 discussed above. The corner 394 includes a corner wall 450 having a generally concave curvature including a concave inner surface 452. The concave inner surface 452 circulates the pre-embedding treatment fluid along an arcuate path around the compartment 312 rather than directing the fluid into a perpendicularly oriented wall, as do the angled corners of the cassette of U.S. Pat. No. 5,928,934.

As shown in FIG. 19, the apertures 400 of the corner 394 are each oriented to extend vertically along a vertical axis 454. The axis 454 is generally perpendicular to the bottom wall 360, which extends generally horizontally. In one approach, the cassette 302 is formed by injecting plastic into a mold. The mold may have upper and lower parts that move vertically together and apart relative to each other during the molding process. The vertical orientation of the apertures 400 makes it easier for the portions of the mold that form the apertures 400 to be withdrawn when the upper and lower parts of the mold are moved vertically apart from each other to release the formed cassette 302. It is intended that the generally perpendicular orientation of the axis 454 relative to the bottom wall 360 encompasses slight variation from a ninety degree angle between the axis 454 and the bottom wall 360, such as a variation in the range of one degree to five degrees as examples.

The corner 394 also includes a juncture 455 having a curvature that matches a portion of an Archimedean spiral, as discussed above with respect to juncture 364. The juncture 455 transitions between the generally planar bottom wall 360 and the concave, widening corner wall 450 which extends away from the bottom wall 360. The juncture 455 reduces the capillary action produced by the corner 394 so that smaller tissue specimens are maintained in the center of the compartment 312.

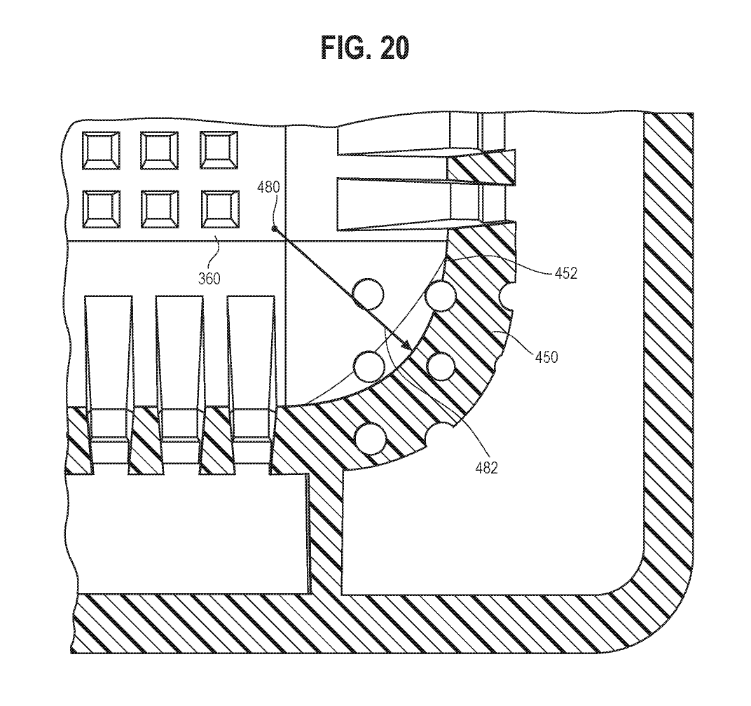

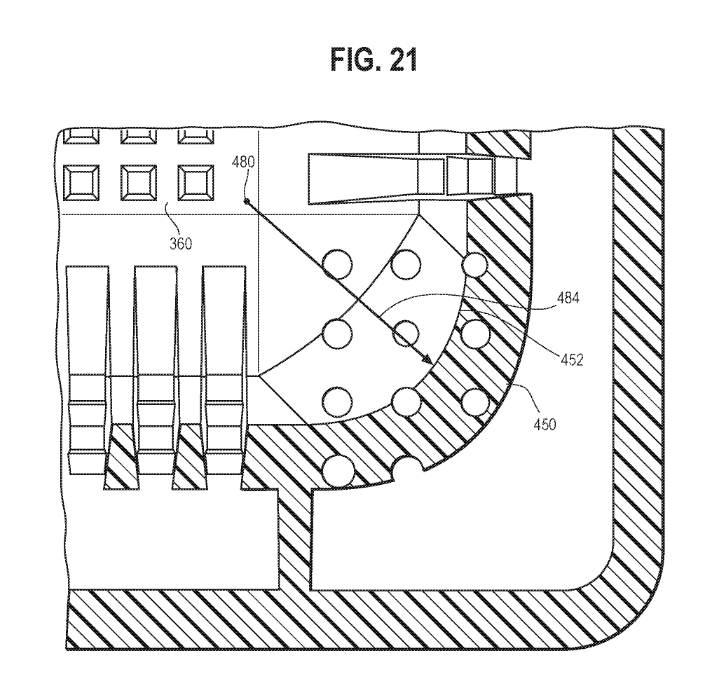

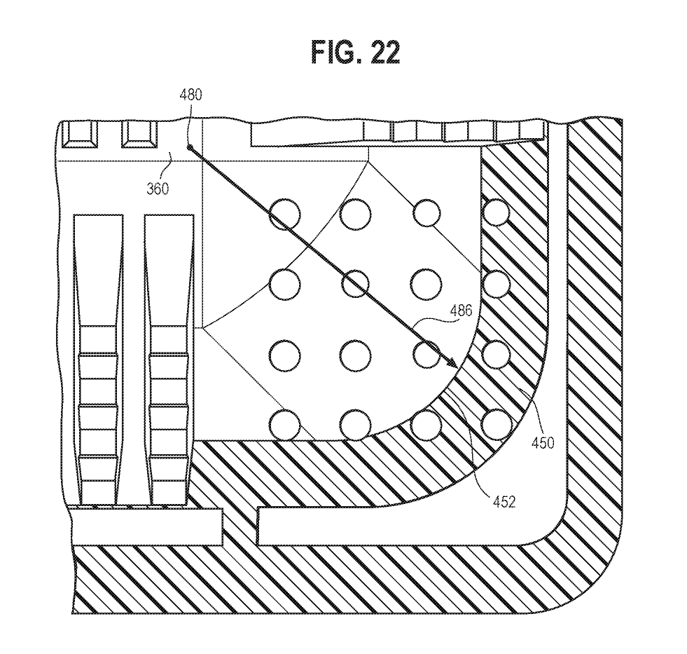

With reference to FIG. 20, the corner wall 450 has a varying curvature as the corner wall 450 extends upward away from the bottom wall 360. In particular, an axis 480 may extend normal to the bottom wall 360 (and out of the page in FIG. 20) and a radius 482 may extend perpendicular to the axis 480. With reference to FIGS. 21 and 22, the cross-sections have been taken at progressively higher elevations along the corner wall 450 than the cross-section in FIG. 20. By comparing FIGS. 20-22, the corner wall 450 has a radius 484 from the axis 480 that is larger at the cross-section taken at FIG. 21, and an even larger radius 486 at the cross-section taken in FIG. 22. In this manner, the corner 390 continues to provide a smooth transition between the rear wall 352 and the side wall 356 even as the rear wall 352 and side wall 356 continue to get farther and farther apart higher and higher up the corner 394. This improves circulation of pre-embedding fluids in the compartment 312 whether the fluids are near the bottom wall 360 or near the upper end of the compartment 312.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention. Further, terms of orientation and direction in the foregoing description such as upper, lower, horizontal, vertical, etc. are used for convenience and are not intended to limit the claims.

What is claimed is:

1. A generally rectangular cassette for handling a biological specimen, the cassette comprising:
a biological specimen-receiving compartment including a bottom wall, a front wall, a rear wall, and a pair of side walls, wherein the front wall, rear wall, and side walls extend obliquely to the bottom wall;
at least one curved juncture of the compartment connecting the bottom wall and one of the front wall, rear wall, and side walls; and
the at least one curved juncture curving upwardly away from the bottom wall with a curvature that matches a portion of an Archimedean spiral.

2. The cassette of claim 1 wherein the at least one curved juncture curves upwardly away from the bottom wall with a curvature that continuously increases as the juncture curves away from the bottom wall.

3. The cassette of claim 1 wherein the bottom wall has a periphery and the at least one curved juncture curves upwardly away from the periphery of the bottom wall with a curvature that matches a portion of an Archimedean spiral described in polar coordinates by the equation R=b×θ, wherein b is a real number.

4. The cassette of claim 1 wherein the at least one curved juncture includes at least four curved junctures, the at least four curved junctures each connecting the bottom wall to one of the front wall, rear wall, and side walls.

5. The cassette of claim 1 wherein the at least one curved juncture includes a plurality of apertures therein.

6. The cassette of claim 1 wherein the cassette is of a plastic material and is in combination with a metallic base mold having a cavity sized to receive the cassette.

7. The cassette of claim 1 wherein the bottom wall, front wall, rear wall, and side walls each include a plurality of apertures.

8. A generally rectangular cassette for handling a biological specimen, the cassette comprising:
a biological specimen-receiving compartment including a bottom wall, a front wall, a rear wall, and a pair of side walls, wherein the front wall, rear wall, and side walls extend obliquely to the bottom wall;
at least one curved corner of the biological specimen-receiving compartment connecting one of the side walls to one of the front wall and the rear wall; and
the at least one curved corner widens as the curved corner extends away from the bottom wall.

9. The cassette of claim 8 wherein the at least one curved corner has a radius of curvature extending perpendicular to an axis extending normal to the bottom wall and the radius of curvature increases as the at least one curved corner extends away from the bottom wall.

10. The cassette of claim 8 wherein the at least one curved corner includes a plurality of apertures.

11. The cassette of claim 10 wherein the bottom wall extends horizontally and the apertures of the at least one curved corner extend vertically through the at least one curved corner.

12. The cassette of claim 8 wherein the at least one curved corner includes a second curved corner connecting the one side wall to the other of the front wall and the rear wall, wherein the second curved corner widens as the curved corner extends away from the bottom wall.

13. The cassette of claim 12 wherein the second curved corner includes a plurality of apertures.

14. The cassette of claim 8 wherein the at least one curved corner includes a second curved corner connecting the one side wall to the other of the front wall and the rear wall; and
a pair of curved corners connecting the other side wall to the front wall and the rear wall.

15. The cassette of claim 8 wherein the bottom wall, front wall, rear wall, and side walls each have a plurality of apertures.

16. A biological specimen handling apparatus comprising:
a generally rectangular cassette for supporting a tissue specimen and including a bottom wall with a plurality of apertures;
a base mold of metallic material having a body including a lower cavity for receiving the tissue specimen and a generally rectangular upper cavity sized to receive the cassette; and
a cam member of the metallic base mold configured to direct the cassette downward into the upper cavity as a user urges the cassette against the cam member without causing deflection of the cam member relative to the base mold body.

17. The apparatus of claim 16 wherein the upper cavity of the rigid base mold includes a generally horizontally extending shelf surface for supporting a lower surface of the cassette and the cam member extends at an acute angle relative to the horizontally extending shelf surface of the base mold.

18. The apparatus of claim 16 wherein the cam member of the base mold includes an inclined tab and the cassette includes an inclined front surface, the inclined tab and the inclined front surface extending in the same direction and extending substantially parallel to each other.

19. The apparatus of claim 16 wherein the cassette includes an inclined front surface and the cam member includes a tab against which the cassette front surface is engaged and directed downwardly.

20. The apparatus of claim 19 wherein the upper cavity of the base mold includes a substantially flat surface for supporting a lower surface of the cassette and the tab extends above the upper cavity at an acute angle relative to the substantially flat surface.

21. The apparatus of claim 16 wherein the upper cavity of the base mold includes a plurality of walls that extend about a periphery of the cassette with the cassette seated in the upper cavity and the cam member extends inwardly above the cassette from one of the walls.

22. A biological specimen handling apparatus comprising:
a cassette for supporting a tissue specimen, the cassette having upper and lower surfaces and a height therebetween;
front and rear walls of the cassette extending between the upper and lower surfaces thereof;
a base mold having a lower cavity for receiving the tissue specimen and an upper cavity for receiving the cassette;
a support surface of the base mold upper cavity for supporting the lower surface of the cassette;
a rear wall of the upper cavity sized to extend upwardly along the rear wall of the cassette for less than the height of the cassette with the cassette received in the upper cavity; and
a front cam member of the base mold disposed across the upper cavity from the rear wall and being configured to direct the cassette downward into the upper cavity as a user urges the cassette along the support surface and against the cam member.

23. The apparatus of claim 22 wherein the base mold is metallic and the front cam member and the rear wall of the base member are configured to permit the cassette to be seated in the upper cavity without deformation of the front cam member and the rear wall of the base member.

24. The apparatus of claim 22 wherein the front cam member includes a tab extending in a first direction at an acute angle relative to the support surface of the upper cavity and the front wall of the cassette includes an inclined surface that extends in the first direction at substantially the same acute angle as the tab with the cassette received in the base member upper cavity.

25. The apparatus of claim 22 wherein the upper cavity includes a front wall having a height less than the height of the cassette and the front cam member extends from the front wall upwardly and toward the rear wall.

26. The apparatus of claim 25 wherein the upper cavity includes side walls each having a height less than the height of the cassette and extending between the front and rear walls of the upper cavity.

27. The apparatus of claim 22 wherein the upper cavity includes a generally horizontally extending shelf surface for supporting the lower surface of the cassette and the front cam member extends above the upper cavity at an acute angle relative to the horizontally extending surface of the upper cavity.
